(19) United States
(12) Patent Application Publication
(10) Pub. No.: US 2011/0131408 A1
(43) Pub. Date: Jun. 2, 2011

(54) DOCUMENT LINK SECURITY

(75) Inventors: JOHN A. COOK, Grand Rapids, MI (US); Michael Sielian, Littleton, MA (US)

(73) Assignee: International Business Machines Corporation, Armonk, NY (US)

(21) Appl. No.: 12/628,650

(22) Filed: Dec. 1, 2009

(51) Int. Cl. G06F 12/14; H04L 29/06

(52) U.S. Cl. 713/153; 713/189

(57) ABSTRACT

A method, system, and computer usable program product for document link security are provided in the illustrative embodiments. A link is created to a document stored in a data storage device accessible from a data processing system. A characteristic of the document is encrypted in the link. The link with the encrypted characteristic forms an encrypted locator. The encrypted locator may be embedded into another data, such as a page, which may be transmitted with the embedded encrypted locator. A request for the document may be received. The request may include encrypted information. The encrypted information may be the encrypted locator, the encrypted characteristic, or a combination thereof. The encrypted information is decrypted. The document is accessed using the decrypted information. The document is provided in response to the request.

### BACKGROUND OF THE INVENTION

1. Field of the Invention

The present invention relates generally to an improved data processing system, and in particular, to a computer implemented method for providing information over a data network. Still more particularly, the present invention relates to a computer implemented method, system, and computer usable program code for providing document link security.

2. Description of the Related Art

Data is frequently exchanged between various data processing systems using one or more data networks. Some data networks may be regarded as public networks, such as wide area networks accessing the Internet. Other data networks may be private networks, such as local area networks, and virtual private networks (VPNs).

A data processing system situated in a public network may communicate with a data processing system situated in a private network through a variety of devices and applications. Such communications may cause an exchange of data between any combination of data processing systems in public and private networks.

Security of the data, the systems the data resides on, and the networks where the systems operate, is a concern in data communications. Data is often organized into files, data structures, and groupings thereof, collectively referred to as documents. Documents can exist in a variety of formats, and can include a variety of types of data. Some examples of documents are image files, spreadsheets, word-processing documents, Hypertext Markup Language (HTML) document, text files, and files containing data structures of database records. Sometimes, entire documents are exchanged as a result of data communication between data processing systems.

Besides the data content of a document, the document includes or is associated with many other characteristics. For example, a document may be associated with a name, a location in a data processing environment, a time of creation, a descriptor of a nature of the contents, and one or more indicators of association of the document with other documents.

### SUMMARY OF THE INVENTION

The illustrative embodiments provide a method, system, and computer usable program product for document link security. According to the invention, an embodiment creates a link to a document stored in a data storage device accessible from a data processing system. The embodiment encrypts a characteristic of the document in the link. The link with the encrypted characteristic forms an encrypted locator. The embodiment embeds the encrypted locator into a page. The embodiment transmits the page with the embedded encrypted locator.

### BRIEF DESCRIPTION OF THE DRAWINGS

The novel features believed characteristic of the invention are set forth in the appended claims. The invention itself; however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of a configuration using linked documents with respect to which an illustrative embodiment may be implemented;

FIG. 4 depicts a block diagram of an example configuration for using securely linked documents in accordance with an illustrative embodiment;

FIG. 5A depicts an example unencrypted file URL in accordance with an illustrative embodiment;

FIG. 5B depicts an example encrypted URL in accordance with an illustrative embodiment;

FIG. 6 depicts a block diagram of an encryption component in accordance with an illustrative embodiment;

FIG. 7 depicts a block diagram of a decryption component in accordance with an illustrative embodiment;

FIG. 8 depicts a flowchart of a process of sending an encrypted URL in accordance with an illustrative embodiment; and

FIG. 9 depicts a flowchart of a process of decrypting an encrypted URL in accordance with an illustrative embodiment.

### DETAILED DESCRIPTION OF THE PREFERRED EMBODIMENT

An application executing on one data processing system can share a document with another application executing on another data processing system. Sharing a document includes transmitting, receiving, saving or copying to a data storage device, or otherwise exchanging the document. One example of sharing a document is when an internet browser application requests a document from a web server. As an example, a browser may request from a web server an image file, a spreadsheet, a word-processing document, or any other kind of document available at the web server.

The invention recognizes that a document can be referenced, or made accessible from within other data exchanged between applications. For example, a document can be embedded using a link, such as a uniform resource locator (URL) link, in a page sent to a browser. A link is any text, image, area, icon, shape, or code that is usable for accessing a resource, such as a document. A page is a collection of information that is organized in a predetermined form.

Selecting, activating, or otherwise manipulating the link transmits a request for the linked resource to an application. For example, manipulating a link to a document may send a request for the document to a web server application. The web server provides the browser the document located at the location identified in the link.

A link according to the invention includes a locator. A locator is any form of data or data structure usable for locating a resource, such as a document. Some examples of locators that are within the scope of the invention are resource names, resource addresses, filenames, file-paths, encoded identifiers, pointers, handles, keywords, search references, or a combination thereof. A URL is a type of locator. In some instances, a link may simply be the locator. In other instances, a link may contain additional information, such as code, time, tracking information, security features, and information for many other purposes.

The invention recognizes that sharing documents using links to the document can cause security related issues. The invention recognizes that a link to a document may include a name, a location, or other information describing the document so that the server can locate the document being requested via the link.

The invention further recognizes that one or more characteristics of a document are in plain text form readable by users or recognizable in applications. In other words, a user or an application may be able to read a link to a document and may learn the name of the document, the location of the document at the web server, or other characteristics of the document.

A common technique used for sharing documents is by placing the document in a location accessible to a web server, and allowing a link to that document to be embedded in a page served to a browser. The invention recognizes that presently, a document that is to be shared using a web server in this manner is placed in a location, such as a directory, where other documents may also reside. The invention further recognizes that revealing the location of one document via a link risks revealing the location of other documents that may be present in that location.

The invention recognizes that presently, web servers that share documents via links do not impose security restrictions for accessing the documents. Although a web server can secure access to a linked document via user-id and password or some other security mechanism, such security mechanisms are pose other problems.

For example, a web server may require some security information, such as a user-id and password, before a linked document is made available. However, for such a security measure to be meaningful, the web server has to ask and the browser has to provide the security information each time the document is accessed, and for each document that is accessed. Using the security information in this manner deteriorates the browsing experience and overall performance of the involved applications.

As another example, a web-server may authenticate a session with a browser before allowing requests for linked documents from that browser. However, session authentication is a computationally non-trivial process on the server-side and deteriorates the overall server performance. Furthermore, the linked document may be opened in a target user interface, such as a browser window, separate from the user interface where the request originated. In such a case, the session authentication method of security may not work as the session information for the originating window and the target window may be different.

The invention further recognizes that a presently used link may be subject to other types of abuse. For example, a link that reveals the location or name of a document can be forwarded such that the link can be used to retrieve the document at an undesirable data processing system. As another example, an intruder, by trial and error, may successfully guess the names of other documents that may be present at that location from a text pattern in the name of the linked document. As another example, an intruder may successfully guess and access other locations where other documents may be stored by using a pattern in the location of the linked document.

Generally, when used, practical implementations use passwords or other security measures to secure data at the server level, or directory level, but not at the individual document level to avoid such undesirable side-effects on user-experience and system performance. By not using a security measure at a document level granularity to improve experience and performance, the security measure fails to prevent malicious use of a link to access and use the linked document and other documents.

The illustrative embodiments used to describe the invention generally address and solve the above-described problems and other problems related to linked documents. The illustrative embodiments provide a method, computer usable program product, and data processing system for document link security.

The illustrative embodiments are described with respect to certain documents, data, data structures, file systems, fine names, directories, and paths only as examples. Such descriptions are not intended to be limiting on the invention. For example, an illustrative embodiment described with respect to a document in a local directory of a web server may be implemented with respect to a disk, volume, volume group, or file system accessible over a data network in a similar manner within the scope of the invention.

As another example, links and parts thereof to documents, whether encrypted or decrypted, are described using URLs only for the clarity of the description and are not limiting on the illustrative embodiments. A link within the scope of the invention may not be limited to include only http URLs but may include any form of locator without limitations.

Furthermore, the illustrative embodiments may be implemented with respect to any type of data, data source, or access to a data source over a data network. Any type of data storage device may provide a document to an embodiment of the invention, either locally at a data processing system or over a data network, within the scope of the invention.

The illustrative embodiments are further described with respect to certain applications only as examples. Such descriptions are not intended to be limiting on the invention. An embodiment of the invention may be implemented with respect to any type of application, such as, for example, any type of server application, platform application, stand-alone application, or a combination thereof.

Application may further include data objects, code objects, encapsulated instructions, application fragments, services, and other types of resources available in a data processing environment. For example, Java® object, an Enterprise Java Bean (EJB®), a servlet, or an applet may be manifestations of an application with respect to which, within which, or using which, the invention may be implemented. (Java, EJB, and other Java related terminologies are registered trademarks of Sun Microsystems, Inc. in the United States and other countries.)

An illustrative embodiment may be implemented in hardware, software, or a combination thereof. The examples in this disclosure are used only for the clarity of the description and are not limiting on the illustrative embodiments. Additional or different information, data, operations, actions, tasks, activities, and manipulations will be conceivable from this disclosure for similar purpose and the same are contemplated within the scope of the illustrative embodiments.

The illustrative embodiments are described using specific code, data structures, file systems, designs, architectures, layouts, schematics, and tools only as examples and are not limiting on the illustrative embodiments. Furthermore, the illustrative embodiments are described in some instances using particular software tools and data processing environments only as an example for the clarity of the description. The illustrative embodiments may be used in conjunction with other comparable or similarly purposed structures, systems, applications, or architectures.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

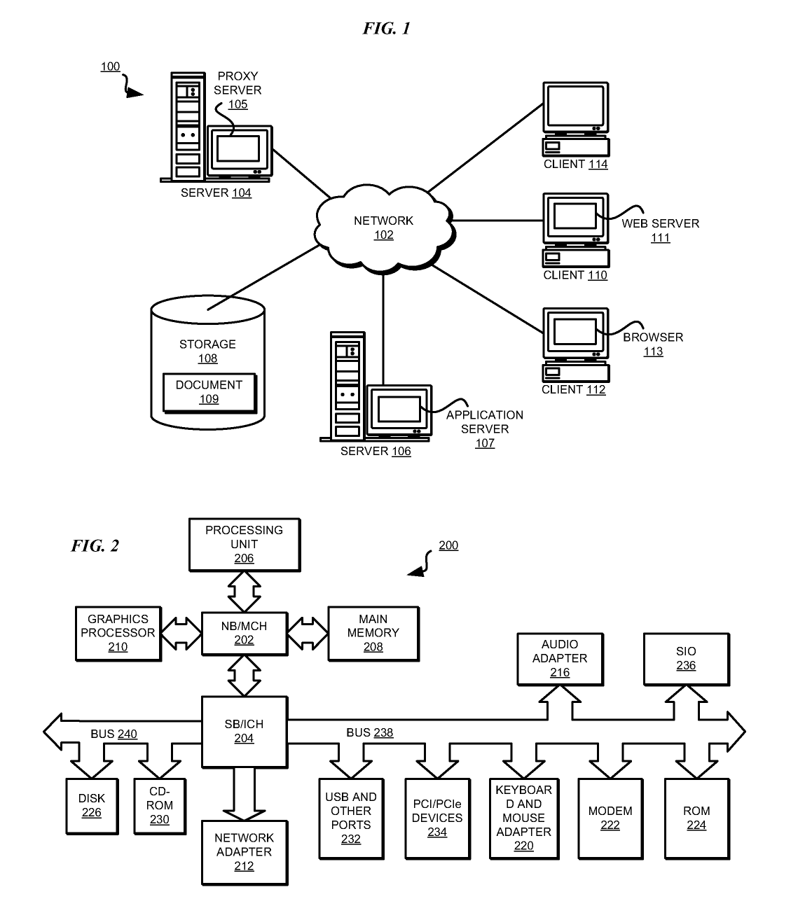

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Server 104 may include proxy server 105. Proxy server 105 may be any application operating to provide some or all functions performed by a commonly used proxy server application. Server 106 may include application server 107. Application server 107 may be any application capable of providing some or all functions of a commonly used application server application. Client 110 may include web server 111. Web server 111 may be any application capable of providing some or all functions of a commonly used web server. Client 112 may include browser 113. Browser 113 may be any application capable of receiving data from a server application, not limited to a commonly used internet browser application. Storage 108 may store document 109. As an example, a link to document 109 may be generated by application server 107, requested by browser 113 using the link, and served by web server 111.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client server environment in which the illustrative embodiments may be implemented. A client server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java is a trademark of Sun Microsystems, Inc., in the United States and other countries).

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

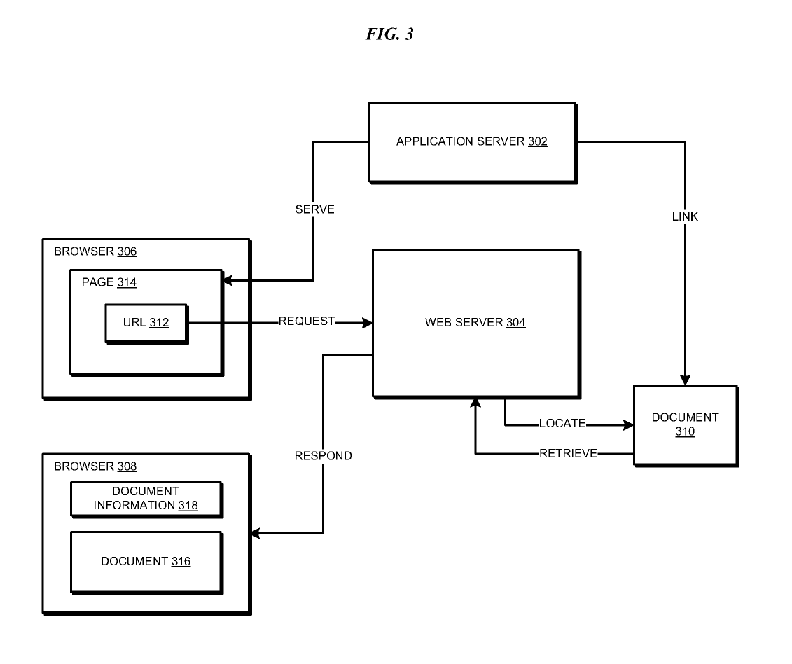

With reference to FIG. 3, this figure depicts a block diagram of a configuration using linked documents with respect to which an illustrative embodiment may be implemented. Application server 302 may be analogous to application server 107 in FIG. 1. Web server 304 may be analogous to webs server 111 in FIG. 1. Browser 306 and browser 308 may each be a window of a browser analogous to browser 113 in FIG. 1. Document 310 may be analogous to document 109 in FIG. 1.

Application server 302 may create a link to document 310. Application server 302 may create the link in response to or in anticipation of an interaction with browser 306. Application server 302 may embed the link as URL 312 in page 314 and serve page 314 to browser 306.

Using the information in URL 312, browser 306 may send a request for document 310 to web server 304. Using the information from URL 312 supplied in the request, web server 304 may locate and retrieve document 310. Web server 304 may respond by transmitting document 310 to browser 308.

Browser 308 may display or otherwise use document 310 as document 316. Information 318 may be a characteristic of document 316, and consequently document 310. In one embodiment, information 318 may be similar to URL 312. In another embodiment, information 318 may be a name, a location, or another characteristic of document 316, or a combination thereof, made available in conjunction with document 316.

Presently, disadvantageously, application server 302 links to document 310 in such a way that URL 312 reveals one or more characteristics of document 310. For example, URL 312 may reveal in a human-readable form the name of document 310, the path to the location of document 310, or both. Additionally, disadvantageously, document information 318, when present, may reveal similar human-readable information about document 310.

With reference to FIG. 4, this figure depicts a block diagram of an example configuration for using securely linked documents in accordance with an illustrative embodiment. Application server 402 may be implemented using application server 302 in FIG. 3. Web server 404, browsers 406 and 408, and document 410 may be analogous to web server 304, browsers 306 and 308, and document 310 respectively in FIG. 3.

In accordance with an illustrative embodiment, upon request or in anticipation thereof from browser 406, application server 402 may generate a link to document 410. Document 410 may be one of several documents accessible from application server 402. In one embodiment, a several documents, including document 410, may be located in a single location from where application server 402 may access document 410. In another embodiment, a collection of documents may be stored on more than one data storage devices scattered across a data network, such as in different business units of a business organization, but accessible from application server 402. In another embodiment, documents may be located on more than several data processing systems on several data networks, such as being located on the networks and data processing systems of different business organizations, but accessible from application server 402.

A business organization that owns, provides, or makes accessible a document is a source of the document. For example, application server 402 may be a part of a web publisher's data processing environment. A news agency may be the source of document 410, a stock brokerage house may be the source of another document, and a government agency may be the source of another document. In this example, three sources with their independent data networks and data processing systems may make different documents available and accessible from application server 402.

Furthermore, different sources may make documents available from within their data processing systems, or via data processing systems of another entity. For example, a company may act as a source of a document that belongs to another company.

Application server 402 may encrypt the link using encryption component 412. Encryption component 412 may be software code, hardware-based encryption module, or a combination thereof. Encryption component 412 encrypts the link to document 410 using an encryption algorithm such that the encrypted link is completely or partially cipher text, not human-comprehensible. Encrypted link from encryption component 412 is converted to encrypted URL 414, embedded in page 416 and served to browser 406.

Encrypted link from encryption component 412 is described as being converted to encrypted URL 414 only as an example for the clarity of the description. A link may not be limited in information sufficient only to form a URL or another type of locator. A link may include more information than the information contained in a given type of locator.

For example, in one embodiment, a link, such as encrypted link from encryption component 412, may include additional information that may be converted to a URL, such as encrypted URL 414, and additional information. Such additional information may also be passed along with the locator. For example, such additional information may be embedded in page 416 in addition to encrypted URL 414.

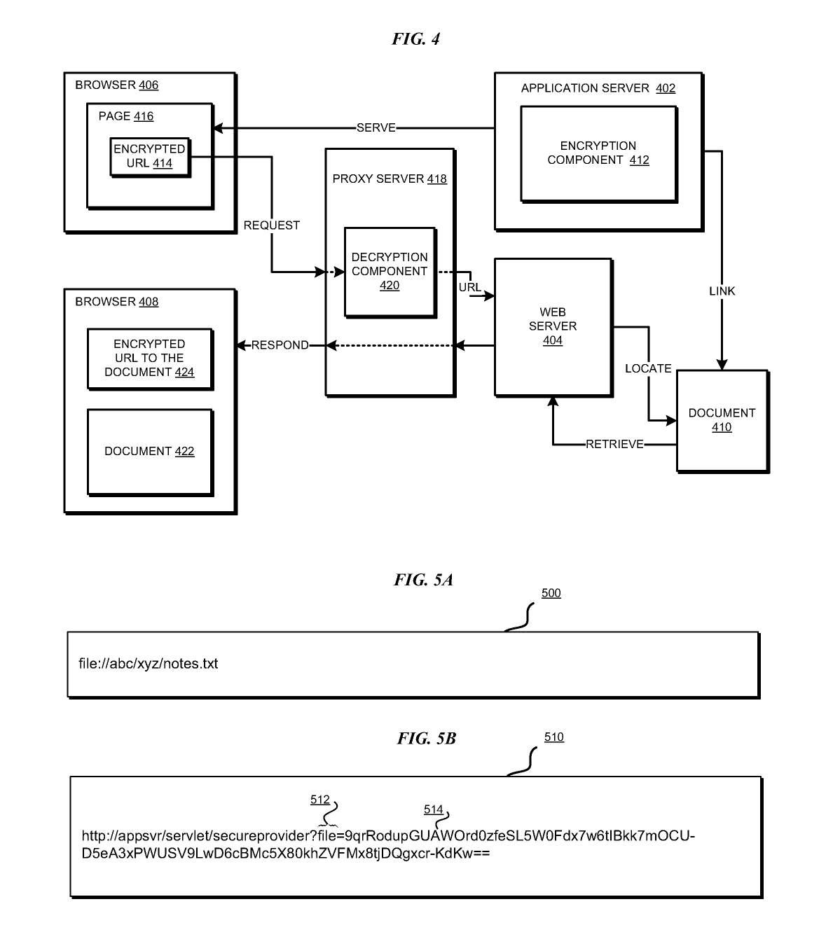

Encrypted URL 414 may be completely or partially cipher text. In one embodiment, a portion of encrypted URL 414 may be human-readable plain-text, whereas a URL parameter therein may be cipher-text reference to document 410. As an example, a URL parameter may be a name-value pair, the name of the parameter being “file”, and the value of the parameter being the cipher text. A depiction of this example appears in FIG. 5.

Browser 406 may use encrypted URL 414 to request an associated document, such as from proxy server 418. Proxy server 418 may be implemented using proxy server 105 in FIG. 1. A request from browser 406 to proxy server 418 may include the all or part of encrypted URL 414. For example, in one embodiment, proxy server 418 may receive the entire encrypted URL 414 in the request from browser 406. In another embodiment, proxy server 418 may receive only a URL parameter, such as the value of the “file” parameter as described in the above example, in the request from browser 406.

Proxy server 418 includes decryption component 420. Decryption component 420 detects the presence of one or more encrypted data in the request received by proxy server 418. Decryption component 420 decrypts one or more encrypted data in the request to recreate the URL to document 410.

Proxy server 418 forwards the decrypted URL to web server 404. Web server 404 locates and retrieves document 410 based on the decrypted URL from proxy server 418. Web server 404 responds by sending document 410 to browser 408. Browser 408 presents document 410 as document 422. Browser 408 may also present encrypted URL 424 to the document. Encrypted URL 424 may be similar to encrypted URL 414.

Browsers 406 and 408 are depicted as separate browser windows only as an example to illustrate the operation of the illustrative embodiment. In one embodiment, document 422 may be presented in browser 406.

Encryption component 412 and decryption component 420 are depicted as separate components executing in different applications only as an example. In one embodiment, encryption component 412 and decryption component 420 may be configured to execute within one application within the scope of the invention. For example, an implementation may have a single server application servicing the browser requests. In such an implementation, the same server may encrypt URLs and decrypt them within the scope of the invention.

Decryption component 420 is shown to send a URL to web server 404 only as an example. In an implementation within the scope of the illustrative embodiments, decryption component 420 may send the locator information for locating a document in any manner suitable to the implementation. For example, in an embodiment, decryption component 420 may send a file path and filename instead of a URL. In another example embodiment, decryption component 420 may send just a filename that can be suitably resolved to a document at web server 404.

Furthermore, web server 404 is depicted only as an example and is not limiting on the illustrative embodiments. In one embodiment, web server 404 may be a data storage device, such as a network attached storage (NAS, a storage area network (SAN), or a component thereof. In another embodiment, web server 404 may be any type of server, application, device or a combination thereof that can be configured for a similar purpose as depicted in FIG. 4.

Additionally, in one embodiment, proxy server 418, using decryption component 420, may redirect requests to other servers, such as web server 404. In another embodiment, the combination of proxy server 418 and decryption component 420 may act as a suitable front-end application to transform incoming requests so that a particular back-end application or device may locate and provide the requested document.

For example, as in an embodiment described above, a back-end device may be a NAS device. In such an example embodiment, proxy server 418 with decryption component 420 may transform the decrypted portion of an example http request into a file-path and filename, which may be usable by the back-end NAS device to locate and deliver the requested document. Depending on a particular combination of factors, proxy server 418 in combination with decryption component 420 may act as a suitable front-end for transforming a variety of types of requests for documents. Some example factors that may help determine the configuration of this frond-end may be the type of a sender of a request, the form of the request, the type of target receiver that should receive a part of the request, the form of the receiver, and the form of requests the receiver is configured to handle.

Operating in this manner, the illustrative embodiment provides certain efficiencies in the operation of the configuration of FIG. 4. For example, web server 404 can service the request from browser 406 without having to validate the request with application server 402. Neither proxy server 418, nor web server 404 has to perform any session based authentication or use a password based security mechanism to provide document link security. Browser 406 or 408, or a user using browser 406 or 408, may not be able to determine the characteristics of the linked document before or after the document is retrieved.

With reference to FIG. 5A, this figure depicts an example unencrypted file URL with respect to which an illustrative embodiment may be implemented. Example URL 500 depicts a link to an example file “notes.txt” whose file-path is “/abc/xyz” from a given root directory. URL 500 is depicted only as an example of a document link that may benefit from an embodiment of the invention. Many other forms of links to files exist and may be modified in using an illustrative embodiment of the invention.

With reference to FIG. 5B, this figure depicts an example encrypted URL in accordance with an illustrative embodiment. Encrypted URL 510 may be presented as encrypted URL 414, encrypted URL 424, or both in FIG. 4.

As an example, encrypted URL 510 is shown to include URL parameter 512. The name of URL parameter 512 is “file”, and the value is cipher text 514.

As depicted, cipher text 514 appears to be an incomprehensible string of alphanumeric characters and symbols. Upon decryption, cipher text 514 yields a URL understandable by a server, such as a web server or an application server, as usable for locating a document.

Encrypted URL 510 and the contents thereof are depicted only as an example and are not intended to be limiting on the invention. Any URL or part thereof can be encrypted in any suitable manner, using any suitable encryption algorithm without departing the scope of the invention. PGP and public key encryption are some examples of encryption algorithms that may be used for encrypting URLs, locators, links, or parts thereof within the scope of the invention.

With reference to FIG. 6, this figure depicts a block diagram of an encryption component in accordance with an illustrative embodiment. Encryption component 602 may be used as encryption component 412 in FIG. 4.

Encryption component 602 may receive document URL 604 as an input. In one embodiment, document URL 604 may be the link to the document that the application server generates in response to or in anticipation of a browser request.

In an embodiment, encryption component 602 may use a predetermined encryption algorithm to encrypt document URL 604. In another embodiment, encryption algorithm 606 may be suggested, indicated, selected, or otherwise provided to encryption component 602. Furthermore, encryption algorithm 606 may be changed as and when suitable to change the encryption performed by encryption component 602 within the scope of the invention. Encryption component 602 produces encrypted URL 608 by encrypting document URL 604 according to an encryption algorithm.

In one embodiment, additional security features may be added to the encryption process. For example, an implementation may desire that encrypted URL 608 should expire one minute after serving the page containing encrypted URL 608. Accordingly, an expiration time may be encoded within encrypted URL 608.

Another example implementation may desire that encrypted URL 608 be generated in response to a specific request from a specific internet protocol address (IP address). Accordingly, the requesting IP address may be encoded within encrypted URL 608.

The expiration time and the requesting IP address are described only as example security features that can be additionally encoded in encrypted URL 608 to add additional layers of security to document links. A security feature is any information or mechanism that can be checked for ascertaining the integrity and/or the validity of associated data. Many other security features will be conceivable from this disclosure and the same are contemplated within the scope of the invention.

One or more security features 610 may also be provided as inputs to encryption component 602 for use in the encryption process. Encryption component 602 may encode one or more security features 610 in generating encrypted URL 608.

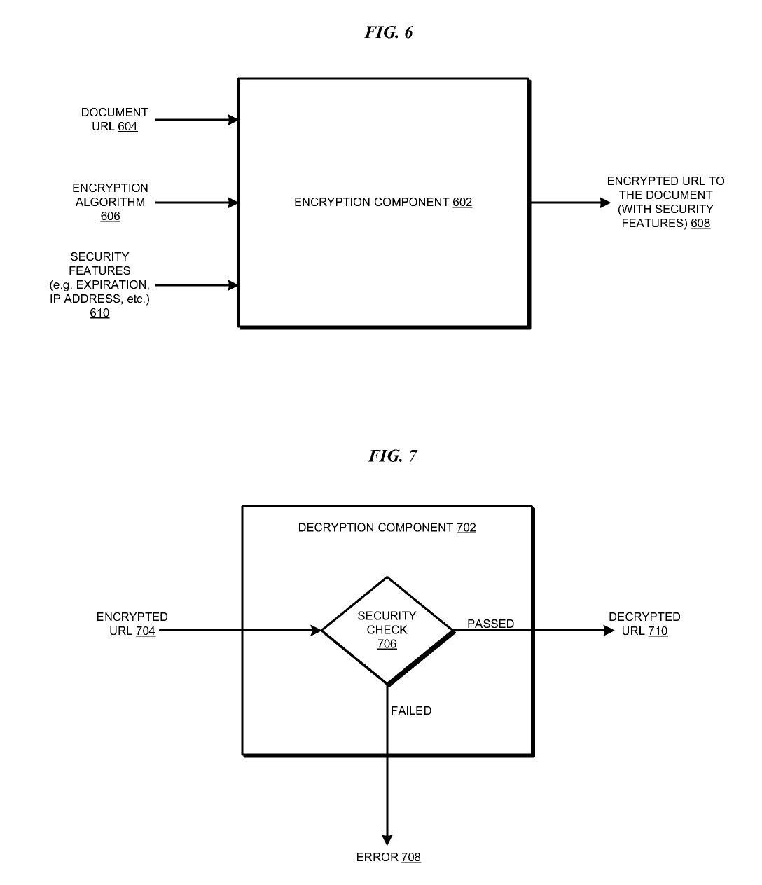

With reference to FIG. 7, this figure depicts a block diagram of a decryption component in accordance with an illustrative embodiment. Decryption component 702 may be used as decryption component 420 in FIG. 4.

Decryption component 702 receives as an input encrypted URL 704. Encrypted URL 704 may be all or part of encrypted URL 608 in FIG. 6.

Decryption component 702 may perform security check 706 on encrypted URL 704, such as when encrypted URL 704 includes one or more security features. For example, encrypted URL 704 may be encoded with an IP address associated with a browser that originally requested a page that contained encrypted URL 704. Security check 704 may determine whether encrypted URL 704 is from the same IP address as encoded within encrypted URL 704 or a different IP address. The IP addresses can differ, if for example, a user requested the page with embedded encrypted URL 704 and then forwarded the page to another data processing system. Another user, perhaps an intruder, may select encrypted URL 704 from the other data processing system and request the associated document.

As another example of the operation of security check 706, assume that encrypted URL 704 is encoded with an expiration time. Security check 706 may determine whether the expiration time has elapsed when encrypted URL 704 is received.

Security check 706 may be configured to check or validate any security feature encoded in encrypted URL 704 in a given implementation within the scope of the invention. If security check 706 fails encrypted URL 704, decryption component 702 may generate error 708 and not respond with the requested document. If security check 706 passes encrypted URL 704, decryption component 702 may decrypt encrypted URL 704 into decrypted URL 710.

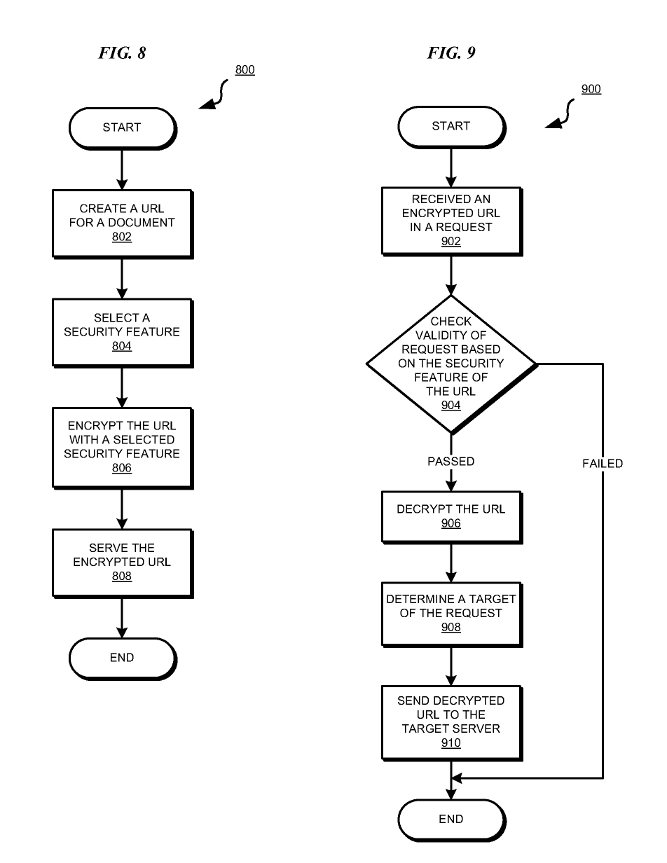

With reference to FIG. 8, this figure depicts a flowchart of a process of sending an encrypted URL in accordance with an illustrative embodiment. Process 800 may be implemented in a server, such as in encryption component 412 of application server 402 in FIG. 4.

Process 800 begins by creating a URL for a document (step 802). Step 802 may be executed generally when an application server generates a link to a document.

Optionally, process 800 may select a security feature to encode in an encrypted URL (step 804). Zero or more security features may be selected in step 804.

Process 800 encrypts the URL created in step 802 including one or more of the security features selected in step 804 (step 806). Process 800 may utilize an encryption algorithm for performing step 806. In one embodiment, process 800 may be supplied with an encryption algorithm as an additional step for performing step 806. In another embodiment, process 800 may utilize a predetermined encryption algorithm for performing step 806.

Process 800 serves the encrypted URL computed in step 806 (step 808). For example, process 800 may embed the encrypted URL into a page that is served to a browser. Process 800 ends thereafter.

With reference to FIG. 9, this figure depicts a flowchart of a process of decrypting an encrypted URL in accordance with an illustrative embodiment. Process 900 may be implemented in a server application, such as in decryption component 420 in proxy server 418 in FIG. 4.

Process 900 begins by receiving an encrypted URL in a request (step 902). In one embodiment, process 900 may receive a complete URL in the request in step 902. In another embodiment, an encrypted part of the URL, such as an encrypted URL parameter, may be received in step 902.

Process 900 checks the validity of the request based on the security feature of the URL received in step 902 (step 904). Operation of step 904 may be similar to the operation of security check 706 described in FIG. 7.

If the check of step 904 fails (“FAILED” path of step 904), process 900 ends thereafter. Optionally (not shown), upon failure of the check of step 904, process 900 may generate one or more error messages or notifications. If the check of step 904 passes the request (“PASSED” path of step 904), process 900 decrypts the encrypted URL (step 906).

Process 900 determines a target of the request received in step 902 (step 908). As an example, when process 900 is implemented in a proxy server, step 908 may determine which web server or application server may be suitable for responding to the request.

Process 900 sends the decrypted URL to the target server identified in step 908 (step 910). Process 900 ends thereafter. Note that a URL is only used as an example in step 910. Process 900 may send a locator in any form to the target server within the scope of the invention. For example, as described with respect to decryption component 420 sending a URL to web server 404 in FIG. 4, a locator sent in step 910 may be a filename, file-path, or a combination thereof.

The components in the block diagrams and the steps in the flowcharts described above are described only as examples. The components and the steps have been selected for the clarity of the description and are not limiting on the illustrative embodiments of the invention. For example, a particular implementation may combine, omit, further subdivide, modify, augment, reduce, or implement alternatively, any of the components or steps without departing from the scope of the illustrative embodiments. Furthermore, the steps of the processes described above may be performed in a different order within the scope of the invention.

Thus, a computer implemented method, apparatus, and computer program product are provided in the illustrative embodiments for providing document link security. Using the embodiments of the invention, a configuration for sharing documents may embed an encrypted link to a document in other data. The encrypted link to the document may prevent human comprehension of information related to a document. The encrypted link may also make machine manipulations to decipher the information related to the document difficult.

According to the invention, communication of the information from the encrypted link between a data processing system requesting a document and the data processing system supplying the document communicates encrypted information. Such communication of encrypted information about the document may prevent malicious or unintended use of the information.

Furthermore, within the configuration for sharing documents, one server may create the links to documents, and a different server may serve the documents when requested from those links. According to the invention, the different servers need not engage in security validation for processing the requests for documents, while maintaining security of the information related to the documents. Thus, the invention may enable light weight security of linked documents that may be advantageous over a security mechanism that is presently configurable.

The illustrative embodiments are described using URLs, http requests, browsers, web servers, application servers only as examples. Within the scope of the invention, a link to a document may be communicated to any type of application in any suitable form. Furthermore, an encrypted link may be decrypted and transformed into any suitable for of locator usable by any application or device on the back-end, not just web servers or application servers within the scope of the invention.

The invention can take the form of an entirely software embodiment, or an embodiment containing both hardware and software elements. In a preferred embodiment, the invention is implemented in software or program code, which includes but is not limited to firmware, resident software, and microcode.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code. A client data processing system may download that computer usable code, such as for storing on a data storage medium associated with the client data processing system, or for using in the client data processing system. The server data processing system may similarly upload computer usable code from the client data processing system. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer usable program product comprising a computer usable storage medium including computer usable code for document link security, the computer usable code comprising:
computer usable code for creating a link to a document stored in a data storage device accessible from a data processing system;
computer usable code for encrypting a characteristic of the document in the link, the link with the encrypted characteristic forming an encrypted locator;
computer usable code for embedding the encrypted locator into a page; and
computer usable code for transmitting the page with the embedded encrypted locator.

2. The computer usable program product of claim 1, where the characteristic of the document is a combination of (i) a name of the document, and (ii) a location of the document.

3. The computer usable program product of claim 1, further comprising:
computer usable code for receiving data describing a security feature; and
computer usable code for encoding the data into the encrypted locator, thereby including the security feature in the encrypted locator.

4. The computer usable program product of claim 3, wherein the data describing the security feature is one of (i) a time, and (ii) an IP address.

5. The computer usable program product of claim 1, wherein the creating the link is in response to a request for the page.

6. The computer usable program product of claim 1, wherein the encrypted characteristic forms a parameter of the encrypted locator.

7. The computer usable program product of claim 1, further comprising:
computer usable code for receiving a request for the document, the request including encrypted information, the encrypted information being one of (i) the encrypted locator, and (ii) encrypted characteristic;
computer usable code for decrypting the encrypted information;
computer usable code for accessing the document using the decrypted information; and
computer usable code for providing, responsive to the request, the document.

8. The computer usable program product of claim 7, further comprising:
computer usable code for checking a security feature encoded in the encrypted information, wherein the decrypting is responsive to the security feature passing the checking.

9. The computer usable program product of claim 7, wherein the creating, encrypting, embedding, and transmitting are performed by a first servlet executing in an application server, and wherein the decrypting, accessing, and providing are performed by a second servlet executing in a proxy server.

10. The computer usable program product of claim 1, wherein the computer usable code is stored in a computer readable storage medium in a data processing system, and wherein the computer usable code is transferred over a network from a remote data processing system.

11. The computer usable program product of claim 1, wherein the computer usable code is stored in a computer readable storage medium in a server data processing system, and wherein the computer usable code is downloaded over a network to a remote data processing system for use in a computer readable storage medium associated with the remote data processing system.

12. A computer implemented method for document link security, the computer implemented method comprising:
creating a link to a document stored in a data storage device accessible from a data processing system;
encrypting a characteristic of the document in the link, the link with the encrypted characteristic forming an encrypted locator;
embedding the encrypted locator into a page; and
transmitting the page with the embedded encrypted locator.

13. The computer implemented method of claim 12, where the characteristic of the document is a combination of (i) a name of the document, and (ii) a location of the document.

14. The computer implemented method of claim 12, further comprising:
receiving data describing a security feature; and
encoding the data into the encrypted locator, thereby including the security feature in the encrypted locator.

15. The computer implemented method of claim 14, wherein the data describing the security feature is one of (i) a time, and (ii) an IP address.

16. The computer implemented method of claim 12, wherein the document is a document in a plurality of documents, the plurality of documents including documents from different sources.

17. The computer implemented method of claim 12, wherein the encrypted characteristic forms a parameter of the encrypted locator.

18. A data processing system for document link security, the data processing system comprising:
a storage device including a storage medium, wherein the storage device stores computer usable program code; and
a processor, wherein the processor executes the computer usable program code, and wherein the computer usable program code comprises:
computer usable code for creating a link to a document stored in a data storage device accessible from a data processing system;
computer usable code for encrypting a characteristic of the document in the link, the link with the encrypted characteristic forming an encrypted locator;
computer usable code for embedding the encrypted locator into a page;
computer usable code for transmitting the page with the embedded encrypted locator;
computer usable code for receiving a request for the document, the request including encrypted information, the encrypted information being one of (i) the encrypted locator, and (ii) encrypted characteristic;
computer usable code for decrypting the encrypted information;
computer usable code for accessing the document using the decrypted information; and
computer usable code for providing, responsive to the request, the document.

19. The data processing system of claim 18, further comprising:
computer usable code for checking a security feature encoded in the encrypted information, wherein the decrypting is responsive to the security feature passing the checking.

20. The data processing system of claim 18, wherein the computer usable code for creating, encrypting, embedding, and transmitting are included in a first servlet executing in an application server, and wherein the computer usable code for decrypting, accessing, and providing are included in a second servlet executing in a proxy server.
